(19) United States
(12) Patent Application Publication
(10) Pub. No.: US 2021/0402998 A1
(43) Pub. Date: Dec. 30, 2021

(54) CONTROL DEVICE AND CONTROL METHOD

(71) Applicant: HONDA MOTOR CO., LTD., Tokyo (JP)

(72) Inventors: Ryoichi Inoue, Wako-shi (JP); Etsuo Watanabe, Tokyo (JP)

(21) Appl. No.: 17/359,709

(22) Filed: Jun. 28, 2021

(30) Foreign Application Priority Data
Jun. 30, 2020 (JP) 2020-112752

(51) Int. Cl. B60W 30/18; B60W 30/09; B60W 60/00; B60W 40/04; B60W 40/105; B60Q 1/52

(52) U.S. Cl. CPC B60W 30/18163; B60W 30/09; B60W 60/0015; B60W 40/04; B60W 2555/60; B60Q 1/525; B60W 2554/804; B60W 2554/806; B60W 40/105

(57) ABSTRACT

A control device detects an object that is present in a traveling direction of a road on which a mobile object is traveling, controls a behavior of the mobile object, acquires an operation state of a turn signal, causes, when a degree of proximity between the mobile object and the detected object is less than a reference, the mobile object to move in a direction intersecting the traveling direction when a predetermined time has elapsed from starting of operating the turn signal obtained from the operation state of the turn signal, and causes, when the degree of proximity is equal to or greater than the reference, the mobile object to move in the direction intersecting the traveling direction before the turn signal is operated or before a predetermined time has elapsed from starting of operating the turn signal.

### CROSS-REFERENCE TO RELATED APPLICATION

Priority is claimed on Japanese Patent Application No. 2020-112752, filed Jun. 30, 2020, the content of which is incorporated herein by reference.

### BACKGROUND

### Field

The present invention relates to a control device and a control method.

### Description of Related Art

Conventionally, a vehicle travel control device that changes a time until acceleration control is performed based on a traveling direction indicated by a turn signal when a vehicle is traveling following a preceding vehicle has been disclosed (refer to Japanese Unexamined Patent Application, First Publication No. 2010-95033).

However, in the conventional art, control of a vehicle in accordance with the presence of an object is not considered. Therefore, appropriate control in accordance with the presence of an object may not be realized in some cases.

### SUMMARY

The present invention has been made in view of such circumstances, and an object of the present invention is to realize more appropriate control of a vehicle according to the presence of an object.

A control device, a control method and a storage medium according to the present invention have adopted the following configurations.

(1): A control device according to one aspect of the present invention includes a memory that stores instructions; and one or more processors, one or more processors execute the instructions to: detect an object that is present in a traveling direction of a road on which a mobile object is traveling, control a behavior of the mobile object, acquire an operation state of a turn signal that notifies traffic participants in a vicinity of the mobile object that the mobile object moves laterally, cause, when a degree of proximity between the mobile object and the detected object is less than a reference, the mobile object to move in a direction intersecting the traveling direction when a predetermined time has elapsed from starting of operating the turn signal obtained from the operation state of the turn signal, and cause, when the degree of proximity is equal to or greater than the reference, the mobile object to move in the direction intersecting the traveling direction before the turn signal is operated or before the predetermined time has elapsed from starting of operating the turn signal.

(2): In the aspect of (1) described above, one or more processors that execute the instructions to: determine that the degree of proximity is equal to or greater than the reference when a first time until the mobile object reaches a reference position of the object is equal to or less than a first threshold value or when a second time until the mobile object passes through a predetermined position after the object passes through the predetermined position is equal to or less than a second threshold value, and cause the mobile object to move in the direction intersecting the traveling direction before the turn signal is operated or before a predetermined time has elapsed from starting of operating the turn signal.

(3): In the aspect of (1) described above, when a speed of the object is less than a speed of the mobile object by a predetermined speed or more, one or more processors execute instructions to: cause the mobile object to move in the direction intersecting the traveling direction before the turn signal is operated or before a predetermined time has elapsed from starting of operating the turn signal.

(4): In the aspect of (3) described above, one or more processors execute instructions to: determine that the degree of proximity is equal to or greater than a reference when a distance between the mobile object and the object is less than a reference distance or when an index obtained by dividing the distance by a speed obtained by subtracting the speed of the object from the speed of the mobile object is less than a reference index, and cause the mobile object to move in the direction intersecting the traveling direction before the turn signal is operated or before a predetermined time has elapsed from starting of operating the turn signal.

(5): In the aspect of (4) described above, one or more processors execute instructions to: determine that the degree of proximity is less than a reference when a distance between the mobile object and the object exceeds a reference distance or when an index obtained by dividing the distance by a speed obtained by subtracting the speed of the object from the speed of the mobile object exceeds a reference index, and cause the mobile object to move in the direction intersecting the traveling direction when a predetermined time has elapsed from starting of operating the turn signal.

(6): In the aspect of (1) described above, one or more processors execute instructions to causes the mobile object to move in the direction intersecting the traveling direction to change a lane of the mobile object from a lane in which the mobile object is traveling to a lane adjacent to the lane.

(7): In the aspect of (1) described above, when the mobile object is traveling on a specific road and the degree of proximity is equal to or greater than a reference, the one or more processors execute instructions to: cause the mobile object to move in the direction intersecting the traveling direction before the turn signal is operated or before a predetermined time has elapsed from starting of operating the turn signal, and the specific road is a road whose restriction speed is equal to or greater than a predetermined speed.

(8): A control device according to another aspect of the present invention includes a memory that stores instructions; and one or more processors, the one or more processors execute the instructions to: detect an object that is present in a traveling direction of a road on which a mobile object is traveling, control a behavior of the mobile object, restrict, when a degree of proximity between the mobile object and the detected object is less than a reference, causing the mobile object to start a behavior of moving in a direction intersecting the traveling direction in a first degree before a predetermined time has elapsed from an operation of a turn signal that notifies traffic participants in the vicinity of the mobile object that the mobile object is moving laterally, and relax the restriction of the first degree before a predetermined time has elapsed from the operation of the turn signal when the degree of proximity is equal to or greater than the reference.

(9): A control method using a vehicle control device according to still another aspect of the present invention includes, processing of detecting an object that is present in a traveling direction of a road on which a mobile object is traveling, processing of controlling a behavior of the mobile object, processing of acquiring an operation state of a turn signal that notifies traffic participants in a vicinity of the mobile object that the mobile object moves laterally, processing of starting to cause, when a degree of proximity between the mobile object and the detected object is less than a reference, the mobile object to move in a direction intersecting the traveling direction when a predetermined time has elapsed from starting of operating the turn signal obtained from the operation state of the turn signal, and processing of starting to cause, when the degree of proximity is equal to or greater than the reference, the mobile object to move in the direction intersecting the traveling direction before the turn signal is operated or before a predetermined time has elapsed from starting of operating the turn signal.

(10): A non-transitory computer-readable storage medium according to still another aspect of the present invention, the computer-readable storage medium that stores a computer program to be executed by a computer to perform at least: detect an object that is present in a traveling direction of a road on which a mobile object is traveling, control a behavior of the mobile object, processing of acquiring an operation state of a turn signal that notifies traffic participants in a vicinity of the mobile object that the mobile object moves laterally, cause, when a degree of proximity between the mobile object and the detected object is less than a reference, the mobile object to move in a direction intersecting the traveling direction when a predetermined time has elapsed from starting of operating the turn signal obtained from the operation state of the turn signal, and cause, when the degree of proximity is equal to or greater than the reference, the mobile object to move in the direction intersecting the traveling direction before the turn signal is operated or before a predetermined time has elapsed from starting of operating the turn signal.

According to (1) to (10), the control device can realize more appropriate control of vehicles according to a presence of an object. For example, the control device can perform more appropriate control by properly using a case in which movement is performed after a turn signal sufficiently notifies traffic participants in the vicinity of a future behavior and a case in which movement is performed in priority of a turn signal sufficiently notifying traffic participants in the vicinity of a future behavior according to a degree of proximity between a mobile object and an object.

According to (2) to (5), the control device can realize appropriate control according to a relative positional relationship between the mobile object and the object. The control device can accurately determine whether to prioritize movement over a notification by a turn signal.

According to (6), the control device can accurately determine whether to perform a lane change by giving priority to the notification by a turn signal or to prioritize a quick lane change over the notification by a turn signal according to a presence of an object, and can realize appropriate vehicle control.

According to (7), the control device can perform appropriate control on a specific road that is an environment where a behavior such as deceleration or stopping is not preferable. For example, since there is no room to avoid falling objects on high-speed roads such as highways, the control device prioritizes movement over the notification by a turn signal if conditions are met. As a result, an appropriate behavior is realized on the basis of a road environment and a relationship between the mobile object and the object.

According to (8), the control device can realize more appropriate vehicle control according to the presence of an object. For example, the control device may perform appropriate control by properly using a case of relaxing a restriction in which movement is performed after a turn signal sufficiently notifies traffic participants in the vicinity of a future behavior and a case of relaxing a restriction in which movement is performed in priority of a turn signal sufficiently notifying traffic participants in the vicinity of a future behavior according to the degree of proximity between the mobile object and the object.

### BRIEF DESCRIPTION OF THE DRAWINGS

FIG. 1 is a configuration diagram of a control system in which a control device according to an embodiment is used.

FIG. 2 is a functional configuration diagram of a first controller and a second controller.

FIG. 3 is a diagram which shows a situation (a part 1) in which first control is performed.

FIG. 4 is a diagram which shows a situation (a part 2) in which the first control is performed.

FIG. 5 is a diagram which shows a situation (a part 3) in which the first control is performed.

FIG. 6 is a diagram which shows a situation in which second control is performed.

FIG. 7 is a flowchart which shows an example of a flow of processing executed by the automated driving control device.

FIG. 8 is a flowchart which shows an example of the flow of the processing executed by the automated driving control device.

FIG. 9 is a flowchart which shows an example of the flow of the processing of a modified example of a first embodiment, which is executed by the automated driving control device.

FIG. 10 is a diagram which shows an example of a functional configuration of a control system of a second embodiment.

FIG. 11 is a flowchart which shows an example of a flow of processing executed by a support controller.

FIG. 12 is a flowchart which shows an example of the flow of the processing executed by the support controller.

FIG. 13 is a diagram for describing a relaxation of a restriction.

FIG. 14 is a diagram which shows an example of a relationship between reaction force and external force before and after the restriction is relaxed.

FIG. 15 is a diagram which shows an example of a hardware configuration of an automated driving control device of the embodiment.

### DETAILED DESCRIPTION

Hereinafter, embodiments of a control device, a control method, and a storage medium of the present invention will be described with reference to the drawings.

### First Embodiment

[Overall Configuration]

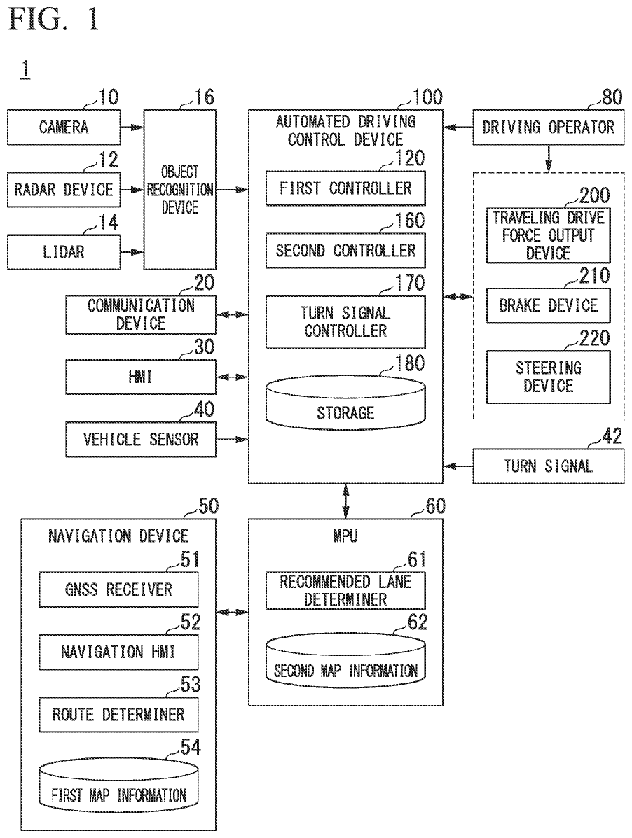

FIG. 1 is a configuration diagram of a control system 1 in which a control device according to an embodiment is used. The control system 1 is mounted in a mobile object. In the following description, the mobile object is assumed to be a vehicle as an example. The vehicle is, for example, a vehicle such as a two-wheeled vehicle, a three-wheeled vehicle, or a four-wheeled vehicle, and its drive source is an internal combustion engine such as a diesel engine or a gasoline engine, an electric motor, or a combination of these. The electric motor operates by using electric power generated by a generator coupled with the internal combustion engine or electric power discharged by a secondary battery or a fuel cell.

The control system 1 includes, for example, a camera 10, a radar device 12, a light detection and ranging (LIDAR) 14, an object recognition device 16, a communication device 20, a human machine interface (HMI) 30, a vehicle sensor 40, a turn signal (a direction indicator) 42, a navigation device 50, a map positioning unit (MPU) 60, a driving operator 80, an automated driving control device 100, a traveling drive force output device 200, a brake device 210, and a steering device 220. These devices and apparatuses are connected to each other by a multiplex communication line such as a controller area network (CAN) communication line, a serial communication line, a wireless communication network, or the like. The configuration shown in FIG. 1 is merely an example, and a part of the configuration may be omitted or another configuration may also be added.

The camera 10 is, for example, a digital camera using a solid-state imaging element such as a charge coupled device (CCD) or a complementary metal oxide semiconductor (CMOS). The camera 10 is attached to an arbitrary place of a vehicle (hereinafter, a vehicle M) on which the control system 1 is mounted. When the front is imaged, the camera 10 is attached to an upper part of the front windshield, a rear surface of the rearview mirror, or the like. The camera 10, for example, periodically and repeatedly images a vicinity of the vehicle M. The camera 10 may be a stereo camera.

The radar device 12 emits radio waves such as millimeter waves to the vicinity of the vehicle M, and also detects radio waves (reflected waves) reflected by an object to detect at least a position (a distance and an orientation) of the object. The radar device 12 is attached to an arbitrary place of the vehicle M. The radar device 12 may detect the position and speed of the object using a frequency modulated continuous wave (FM-CW) method.

The LIDAR 14 irradiates the vicinity of the vehicle M with light (or electromagnetic waves having wavelengths close to that of light) and measures scattered light. The LIDAR 14 detects a distance to a target on the basis of a time from light emission to light reception. The irradiated light is, for example, a pulsed laser beam. The LIDAR 14 is attached to any place of the vehicle M.

The object recognition device 16 performs sensor fusion processing on results of detection performed by some or all of the camera 10, the radar device 12, and the LIDAR 14, and recognizes the position, type, speed, and the like of the object. The object recognition device 16 outputs results of the recognition to the automated driving control device 100. The object recognition device 16 may output the results of the detection performed by the camera 10, the radar device 12, and the LIDAR 14 to the automated driving control device 100 as they are. The object recognition device 16 may be omitted from the control system 1.

The communication device 20 communicates with other vehicles present in the vicinity of the vehicle M by using, for example, a cellular network, a Wi-Fi network, Bluetooth (a registered trademark), dedicated short range communication (DSRC), or the like, or communicates with various server devices via wireless base stations.

The HMI 30 presents various types of information to an occupant of the vehicle M and receives input operations by the occupant. The HMI 30 includes various display devices, speakers, buzzers, touch panels, switches, keys and the like.

The vehicle sensor 40 includes a vehicle speed sensor that detects the speed of the vehicle M, an acceleration sensor that detects the acceleration, a yaw rate sensor that detects the angular speed around a vertical axis, an orientation sensor that detects the direction of the vehicle M, and the like.

The turn signal 42 is a device for notifying the traffic participants in the vicinity of the vehicle M that the vehicle M is moving laterally, such as turning right or turning left of the vehicle M or changing lanes. The traffic participants include vehicles, bicycles, pedestrians, and the like.

The navigation device 50 includes, for example, a global navigation satellite system (GNSS) receiver 51, a navigation HMI 52, and a route determiner 53. The navigation device 50 holds first map information 54 in a storage device such as a hard disk drive (HDD) or a flash memory. The GNSS receiver 51 identifies the position of the vehicle M on the basis of a signal received from a GNSS satellite. The position of the vehicle M may be identified or complemented by an inertial navigation system (INS) using an output of the vehicle sensor 40. The navigation HMI 52 includes a display device, a speaker, a touch panel, a key, and the like. The navigation HMI 52 may be partially or entirely shared with the HMI 30 described above. The route determiner 53 determines, for example, a route (hereinafter, a route on a map) from the position of the vehicle M identified by the GNSS receiver 51 (or an arbitrary position to be input) to a destination input by the occupant using the navigation HMI 52 with reference to the first map information 54. The first map information 54 is, for example, information in which a road shape is expressed by a link indicating a road and a node connected by the link. The first map information 54 may include point of interest (POI) information, curvature, or the like of a road. The route on a map is output to the MPU 60. The navigation device 50 may provide route guidance using the navigation HMI 52 on the basis of the route on a map. The navigation device 50 may be realized by, for example, a function of a terminal device such as a smartphone or a tablet terminal carried by the occupant. The navigation device 50 may transmit a current position and a destination to a navigation server via the communication device 20 and acquire a route equivalent to the route on a map from the navigation server.

The MPU 60 includes, for example, a recommended lane determiner 61, and holds second map information 62 in a storage device such as an HDD or a flash memory. The recommended lane determiner 61 divides the route on a map provided by the navigation device 50 into a plurality of blocks (for example, divides the route by 100 [m] in a vehicle traveling direction), and determines a recommended lane for each block with reference to the second map information 62. The recommended lane determiner 61 determines which lane to drive from the left. When a branch place is present on the route on a map, the recommended lane determiner 61 determines the recommended lane such that the vehicle M can travel on a reasonable route to proceed to the branch destination.

The second map information 62 is more accurate map information than the first map information 54. The second map information 62 includes, for example, information on a center of a lane, information on a boundary of the lane, and the like. The second map information 62 may include road information, traffic regulation information, address information (address/zip code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a deformed steering wheel, a joystick, and other operators. The driving operator 80 is attached to a sensor that detects the amount of an operation or a presence or absence of an operation, and a result of the detection is output to the automated driving control device 100, or some or all of the traveling drive force output device 200, the brake device 210, and the steering device 220.

The automated driving control device 100 includes, for example, a first controller 120, a second controller 160, a turn signal controller 170, and a storage 180. Each of the first controller 120 and the second controller 160 is realized by, for example, a hardware processor such as a central processing unit (CPU) executing a program (software). Some or all of these components may be realized by hardware (circuits; including circuitry) such as large scale integration (LSI), an application specific integrated circuit (ASIC), a field-programmable gate array (FPGA), a graphics processing unit (GPU), or the like, or may be realized by cooperation of software and hardware. The program may be stored in advance in a storage device (a storage device including a non-transient storage medium) such as an HDD or a flash memory of the automated driving control device 100, or may be stored in a detachable storage medium such as a DVD or CD-ROM and installed in the HDD or the flash memory of the automated driving control device 100 by the storage medium (the non-transient storage medium) being mounted in a drive device. The automated driving control device 100 is an example of the “control device.”

The storage 180 is realized by, for example, an HDD, a flash memory, an electrically erasable programmable read only memory (EEPROM), a read only memory (ROM), a random access memory (RAM), or the like. The storage 180 stores, for example, information including a reference, a threshold value, or the like used by the automated driving control device 100 for control to be described below.

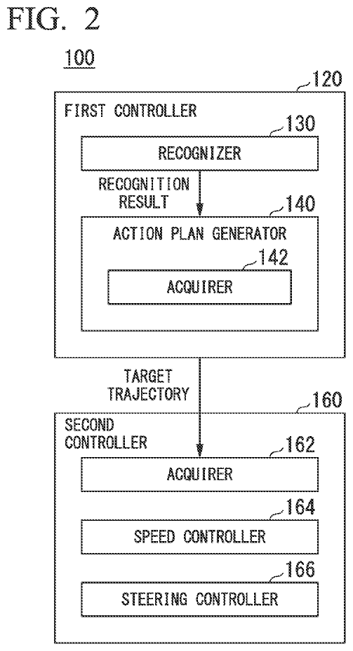

FIG. 2 is a functional configuration diagram of the first controller 120 and the second controller 160. The first controller 120 includes, for example, a recognizer 130 and an action plan generator 140. The first controller 120 realizes, for example, functions by Artificial Intelligence (AI) and functions by a model given in advance in parallel. For example, a function of “recognizing an intersection” may be realized by executing recognition of an intersection by deep learning or the like in parallel with recognition based on conditions given in advance (there are signals capable of pattern matching, road markings, or the like), and may be realized by scoring both sides and comprehensively evaluating them. As a result, reliability of automated driving is ensured. The functional configuration of the recognizer 130 or a combination of the recognizer 130 and the object recognition device 16 is an example of the “detector.” The functional configuration of the first controller 120 or a combination of the first controller 120 and the second controller 160 is an example of the “controller.”

The recognizer 130 recognizes the position and state such as a speed or an acceleration of an object in the vicinity of the vehicle M on the basis of information input from the camera 10, the radar device 12, and the LIDAR 14 via the object recognition device 16. The position of an object is recognized as, for example, a position on absolute coordinates with a representative point of the vehicle M (a center of gravity, a center of drive axis, or the like) as an origin, and is used for control. The position of an object may be represented by a representative point such as the center of gravity or a corner of the object, or may be represented by an expressed area. The “state” of an object may include the acceleration, a jerk, or a “behavior state” (for example, whether a vehicle is changing lanes or intends to change lanes) of the object.

The recognizer 130 recognizes, for example, a lane in which the vehicle M is traveling (a traveling lane). For example, the recognizer 130 recognizes the traveling lane by comparing a pattern of road lane markings obtained from the second map information 62 (for example, an array of solid lines and broken lines) and a pattern of road lane markings in the vicinity of the vehicle M recognized from an image captured by the camera 10. The recognizer 130 may recognize the traveling lane by recognizing not only a road marking line but also a traveling road boundary (a road boundary) including a road marking line, a road shoulder, a curb, a median strip, a guardrail, and the like. In this recognition, the position of the vehicle M acquired from the navigation device 50 and a processing result by the INS may be added. The recognizer 130 recognizes pause lines, obstacles, red lights, tollgates, and other road events. The recognizer 130 recognizes, for example, a guardrail, a width of a sidewalk, a width of a roadway, the number of lanes on a road, and the like.

When the traveling lane is recognized, the recognizer 130 recognizes the position and posture of the vehicle M with respect to the traveling lane. For example, the recognizer 130 may recognize a deviation of a reference point of the vehicle M from a center of the lane and an angle of the vehicle M formed against a line obtained by connecting centers of the lane in the traveling direction as a relative position and the posture of the vehicle M with respect to the traveling lane. Instead, the recognizer 130 may recognize the position of the reference point of the vehicle M with respect to any side end portion (a road lane marking or a road boundary) of the traveling lane, or the like as the relative position of the vehicle M with respect to the traveling lane.

In principle, the action plan generator 140 travels in a recommended lane determined by the recommended lane determiner 61, and generates, furthermore, a target trajectory in which the vehicle M automatically (regardless of an operation from a driver) travels in the future to be able to respond to surrounding situations of the vehicle M. The target trajectory includes, for example, a speed element. For example, the target trajectory is expressed as a sequence of points (trajectory points) to be reached by the vehicle M. The trajectory point is a point to be reached by the vehicle M for each predetermined traveling distance (for example, about several [m]) along a road, and, separately, a target speed and a target acceleration for each predetermined sampling time (for example, about several tenths of a [sec]) generated as a part of the target trajectory. The track point may be a position to be reached by the vehicle M at a corresponding sampling time for each predetermined sampling time. In this case, information of the target speed and the target acceleration is expressed at an interval of trajectory points.

The action plan generator 140 may set an automated driving event when a target trajectory is generated. The automated driving event includes a constant speed traveling event, a low speed following traveling event, a lane change event, a branching event, a merging event, a takeover event, and the like. The action plan generator 140 generates a target trajectory according to an activated event.

The action plan generator 140 has an automatic lane change function. The automatic lane change function refers to a function that the action plan generator 140 automatically causes the vehicle M to change lanes in response to an operation of the turn signal 42 when the occupant causes the turn signal 42 to operate (or performs a predetermined operation).

The action plan generator 140 includes an acquirer 142. The acquirer 142 acquires an operation state of the turn signal 42 from the turn signal controller 170.

The second controller 160 controls the traveling drive force output device 200, the brake device 210, and the steering device 220 so that the vehicle M passes through a target trajectory generated by the action plan generator 140 on time.

The second controller 160 includes, for example, an acquirer 162, a speed controller 164, and a steering controller 166. The acquirer 162 acquires information of the target trajectory (trajectory points) generated by the action plan generator 140 and stores it in a memory (not shown). The speed controller 164 controls the traveling drive force output device 200 or the brake device 210 on the basis of a speed element associated with the target trajectory stored in the memory. The steering controller 166 controls the steering device 220 according to a degree of bending of the target trajectory stored in the memory. Processing of the speed controller 164 and the steering controller 166 is realized by, for example, a combination of feedforward control and feedback control. As an example, the steering controller 166 executes a combination of feedforward control according to the curvature of a road in front of the vehicle M and feedback control based on a deviation from the target trajectory.

Returning to FIG. 1, the turn signal controller 170 controls the operation state of the turn signal 42. The turn signal controller 170 outputs the operation state described above to the first controller 120.

The traveling drive force output device 200 outputs a traveling drive force (torque) for a vehicle to travel to drive wheels. The traveling drive force output device 200 includes, for example, a combination of an internal combustion engine, an electric motor, a transmission, and the like, and an electronic control unit (ECU) that controls these. The ECU controls the configuration described above according to information input from the second controller 160 or information input from the driving operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor according to the information input from the second controller 160 or the information input from the driving operator 80 so that a brake torque corresponding to a braking operation is output to each wheel. The brake device 210 may include a mechanism for transmitting the hydraulic pressure generated by an operation of a brake pedal included in the driving operator 80 to the cylinder via a master cylinder as a backup. The brake device 210 is not limited to the configuration described above, and may be an electronically controlled hydraulic-pressure brake device that controls an actuator according to the information input from the second controller 160 to transmit the hydraulic pressure of the master cylinder to the cylinder.

The steering device 220 includes, for example, a steering ECU and an electric motor. The electric motor applies, for example, force to a rack and pinion mechanism to change a direction of the steering wheel. The steering ECU drives the electric motor according to the information input from the second controller 160 or the information input from the driving operator 80, and changes the direction of the steering wheel.

[First Control and Second Control]

The action plan generator 140 performs at least first control and second control. When the degree of proximity between the vehicle M and an object recognized (detected) by the recognizer 130 is less than a reference, the action plan generator 140 starts to cause the vehicle to move in a direction intersecting the traveling direction when a predetermined time has elapsed from starting of operating the turn signal (an operation of a turn signal) obtained from the operation state of the turn signal 42. Hereinafter, this control may be referred to as the “first control.”

The action plan generator 140 starts to cause the vehicle to move in the direction intersecting the traveling direction before the turn signal is operated or before a predetermined time has elapsed from starting of operating the turn signal when the degree of proximity is equal to or greater than the reference. In the following description, this control may be referred to as the “second control.”

For example, when one or more of the following conditions (1) to (5) are satisfied, the action plan generator 140 determines that the degree of proximity is equal to or greater than the reference, and in other cases, determines that the degree of proximity is less than the reference.

(1) A first time (TTC; Time To Collision) until the vehicle M reaches a reference position of an object (for example, a center of gravity of the object) is equal to or less than a first threshold value.

(2) A second time (a vehicle head time) until the vehicle M passes through a predetermined position after the object passes through the predetermined position is equal to or less than a second threshold value.

(3) The speed of the object is slower than the speed of the vehicle M by a predetermined speed or more.

(4) A distance between the vehicle M and the object is less than a reference distance.

(5) An index obtained by dividing the distance between the vehicle M and the object by a speed obtained by subtracting the speed of the object from the speed of the vehicle M is less than a reference index.

The first threshold value, the second threshold value, the predetermined speed, the reference distance, and the reference index described above are set on the basis of one or both of the speed of the vehicle M and the speed of the object.

The “predetermined time” is, for example, several seconds such as 2 seconds, 3 seconds, or 4 seconds. “Causing the vehicle to move in the direction intersecting the traveling direction” refers to, for example, causing the vehicle M to change lanes to a lane adjacent to a lane in which the vehicle M travels.

The action plan generator 140 may use one or both of the conditions of (4) and (5) described above as a condition for determination when the condition of (3) described above is satisfied. For example, the action plan generator 140 may determine that the degree of proximity is equal to or greater than the reference when the condition of (3) described above is satisfied, and the conditions of (4) and (5) described above are satisfied (when the condition of (4) or the condition of (5) is satisfied), and may determine that the degree of proximity is not equal to or greater than the reference when the condition of (3) described above is not satisfied.

The action plan generator 140 may use the condition of (5) described above as a condition for determination when the condition of (3) or (4) described above is satisfied (when the conditions of (3) and (4) described above are satisfied). For example, when the condition of (3) or (4) described above is not satisfied, the action plan generator 140 determines that the degree of proximity is not equal to or greater than the reference, and determines that the degree of proximity is equal to or greater than the reference when the condition (3) or (4) is satisfied and the condition of (5) is satisfied.

As described above, the action plan generator 140 can easily determine that the degree of proximity is less than the reference by using the condition of (3) or(and) the condition of (4), and determine, furthermore, whether the degree of proximity is equal to or greater than the reference more accurately by using the condition (5) described above when the condition of (3) or(and) the condition of (4) is satisfied.

[Situation in which First Control is Performed (Part 1)]

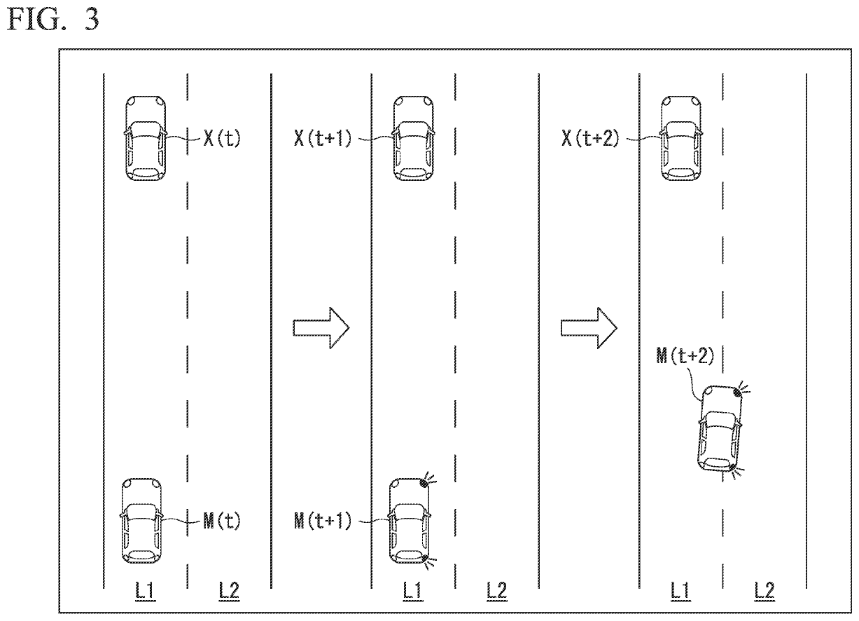

FIG. 3 is a diagram which shows a situation (a part 1) in which the first control is performed. In FIG. 3, the vehicle M and a preceding vehicle X are traveling in a lane L1. A lane L2 is a lane adjacent to the lane L1. The preceding vehicle X is a vehicle that is traveling in front of the vehicle M. The vehicle M recognizes the preceding vehicle X and is traveling behind the recognized preceding vehicle X.

The action plan generator 140 determines to change lanes when, for example, one or more of the following start conditions (A) to (C) are satisfied, and the vehicle M does not interfere with traffic of traffic participants in the vicinity of the vehicle M even if the vehicle M changes lanes. “No interference” means that the behaviors of traffic participants are not suppressed by more than a predetermined degree. “If no interference” means, for example, that there is no behavior in which a vehicle traveling behind the vehicle M in the lane L2 decelerates at a speed reduced by a predetermined degree or more, or a vehicle behind avoids approaching to the vehicle M when assuming that the vehicle M changes lanes to the lane L2.
(A) The vehicle M needs to travel in the lane L2 to reach a destination.
(B) A speed of the preceding vehicle X is lower than a traveling speed or a target speed of the vehicle M by a predetermined speed or more.
(C) The occupant of vehicle M has instructed to change lanes (to start the automatic lane change function).

At a time t, it is assumed that the action plan generator 140 determines to cause the vehicle M to change lanes to the lane L2. When the vehicle M changes lanes, the turn signal controller 170 causes the turn signal 42 to operate at a time t+1. At a time t+2, which is a time when a predetermined time has elapsed from the time when the turn signal is operated, the action plan generator 140 starts to cause the vehicle to move to the lane L2.

In this manner, the action plan generator 140 causes the vehicle M to change lanes after sufficiently notifying traffic participants in the vicinity of a future behavior of the vehicle M. As a result, the traffic participants in the vicinity can more reliably predict the behavior of the vehicle M, so that traffic on a road becomes smoother.

[Situation in which First Control is Performed (Part 2)]

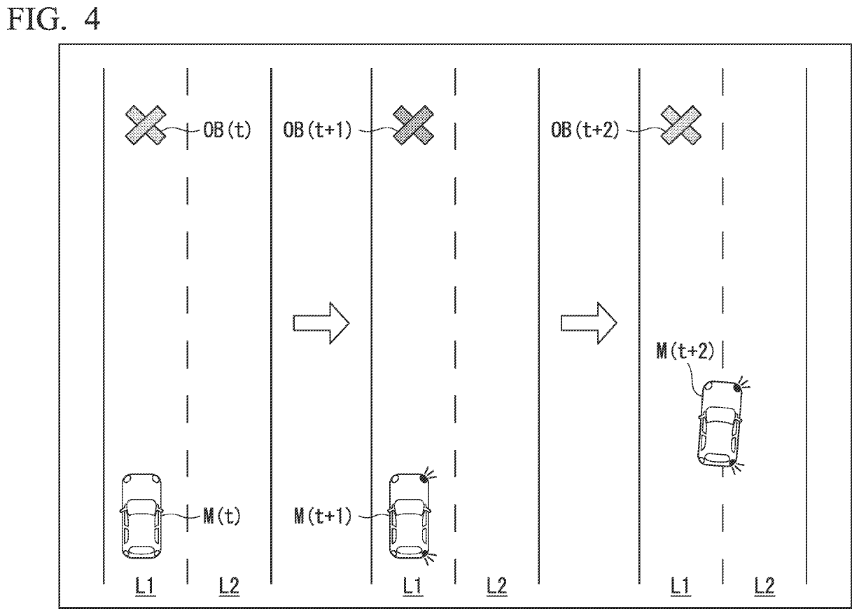

FIG. 4 is a diagram which shows a situation (a part 2) in which the first control is performed. Description that overlaps with the situation (the part 1) will be omitted. In FIG. 4, an object OB is present in front of the vehicle M instead of the preceding vehicle X. The object OB is, for example, stationary. The vehicle M has recognized the object OB a predetermined distance before the object OB.

At the time t, the action plan generator 140 has determined that the vehicle M can change lanes to the lane L2 without approaching the object OB (a predetermined distance before the object) even if the first control is executed, and that the lane change by the vehicle M does not interfere with the traffic of traffic participants in the vicinity of the vehicle M. Then, at the time t+1, the turn signal controller 170 causes the turn signal 42 to operate. At the time t+2, which is the time when a predetermined time has elapsed from the operation of the turn signal, the action plan generator 140 starts to cause the vehicle M to move to the lane L2.

In this manner, the action plan generator 140 causes the vehicle M to change lanes after sufficiently notifying the traffic participants in the vicinity of the future behavior of the vehicle M. As a result, the traffic participants in the vicinity can predict the behavior of the vehicle M more reliably, so that the traffic on the road becomes smoother.

[Situation in which First Control is Performed (Part 3)]

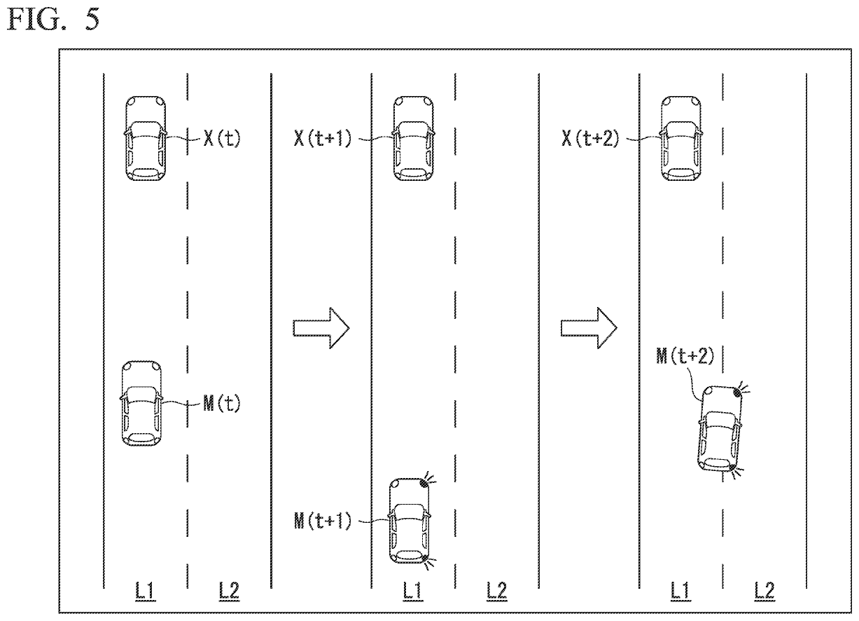

FIG. 5 is a diagram which shows a situation (a part 3) in which the first control is performed. Description that overlaps with the situation (the part 1) will be omitted. In the example of FIG. 5, the vehicle M recognizes the preceding vehicle X at a time before the time t.

At the time t, for example, it is assumed that the preceding vehicle X decelerates or the vehicle M accelerates, so that an inter-vehicle distance between the vehicle M and the preceding vehicle X is less than the reference distance, and the degree of proximity between the vehicle M and the preceding vehicle X is equal to or greater than the reference. In this case, the vehicle M decelerates at a speed reduced by a predetermined degree or more, and executes the first control when the inter-vehicle distance between the vehicle M and the preceding vehicle X is maintained at a distance exceeding the reference distance. Then, the action plan generator 140 decelerates the vehicle M. The speed reduced by a predetermined degree is a reduced speed to the extent that the occupant of the vehicle M does not feel uncomfortable due to the deceleration, and is a preset degree.

As the vehicle M decelerates, the inter-vehicle distance between the vehicle M and the preceding vehicle X is set to a distance exceeding the reference distance at the time t+1. The turn signal controller 170 causes the turn signal 42 to operate. At the time t+2, which is the time when a predetermined time has elapsed from the operation of the turn signal (starting of the operation of the turn signal), the action plan generator 140 starts to cause the vehicle to move to the lane L2.

In this manner, even if the degree of proximity is less than the reference, if the degree of proximity can be maintained to be equal to or greater than the reference, the action plan generator 140 can realize more stable traveling by performing deceleration or sufficiently notifying traffic participants in the vicinity of a lane change.

[Situation in which Second Control is Performed]

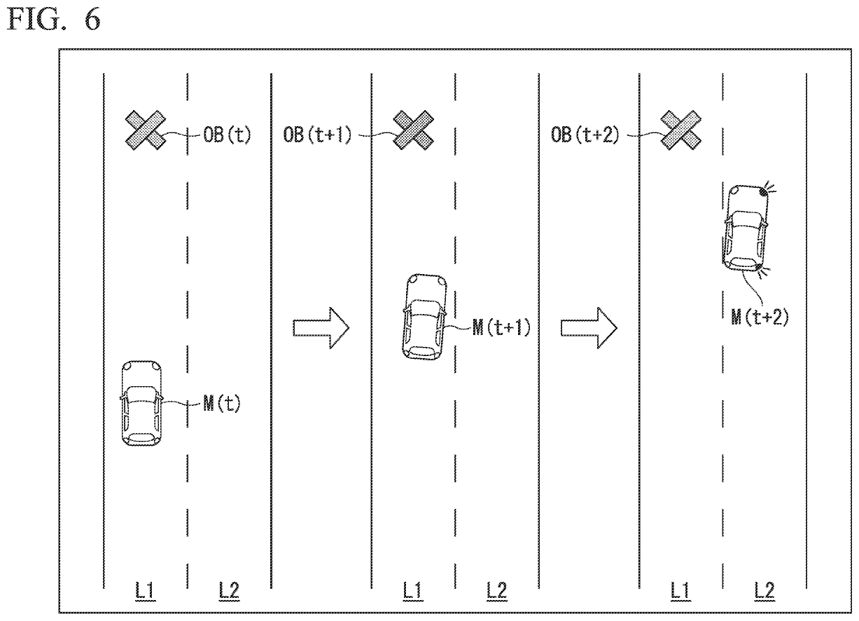

FIG. 6 is a diagram which shows a situation in which the second control is performed. Description that overlaps with the situation (the part 2) will be omitted. In the example of FIG. 6, the vehicle M does not recognize the object OB at a time before the time t. It is assumed that the vehicle M recognizes the object OB at the time t. For example, depending on a shape and a material of the object OB, an environment of a road, and the like, the recognizer 130 can recognize the object OB when the vehicle M approaches the object OB. At this time, the degree of proximity between the vehicle M and the object OB is equal to or greater than the reference, and it may not be appropriate for the traffic participants in the vicinity of the vehicle M or the occupant of the vehicle M to decelerate the vehicle M at a speed reduced by a predetermined degree or more to avoid the object OB, or to stop the vehicle M in front of the object OB. For this reason, the vehicle M executes the second control.

At the time t+1, the vehicle M starts to change lanes regardless of the operation state of the turn signal 42 and the operating time of the turn signal 42 to avoid the object OB. At the time t+2, the action plan generator 140 causes the vehicle M to move to the lane L2.

In this manner, the action plan generator 140 causes the vehicle M to change lanes without considering the operation state of the turn signal 42 and the operating time of the turn signal 42. As a result, it is possible to curb the vehicle M affecting a following vehicle by stopping or decelerating and the occupant of the vehicle M being burdened.

As described above, the action plan generator 140 can realize more appropriate control of a vehicle according to a relative relationship (presence of an object) between the vehicle M and the object present in front of the vehicle M. For example, when the vehicle M changes lanes to overtake a preceding vehicle or changes lanes to reach a destination, it is possible to realize more appropriate vehicle control by prioritizing notification of a future behavior of the vehicle to traffic participants in the vicinity using a turn signal and prioritizing the behavior of the vehicle over the notification for an object that does not provide a room to avoid, such as a falling object.

[Flowchart (First Control)]

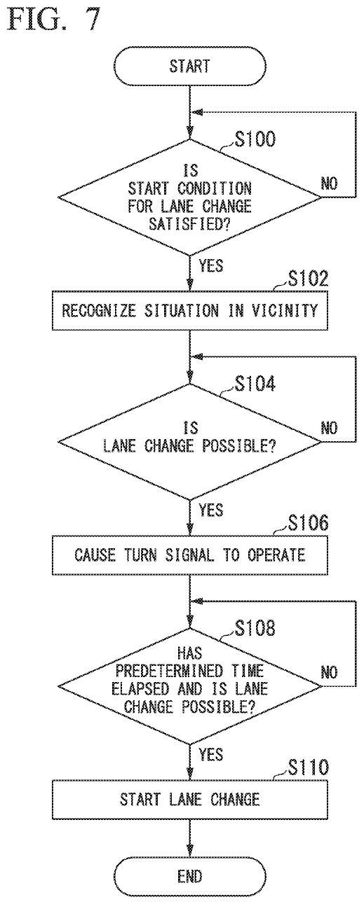

FIG. 7 is a flowchart which shows an example of a flow of processing executed by the automated driving control device 100. An order of the processing executed in this flowchart may be changed, or a part of the processing may also be omitted.

First, the action plan generator 140 determines whether a start condition for a lane change is satisfied (step S100). When the start condition for a lane change is satisfied, the recognizer 130 recognizes the vicinity of the vehicle M (step S102).

Next, the action plan generator 140 determines whether a lane change is possible on the basis of a result of the recognition in step S102 (step S104). For example, the action plan generator 140 determines that a lane change is not possible when it is determined that there are traffic participants who will interfere with the lane change on an assumption that the lane change has been executed, and determines that a lane change is possible when it is determined that there are no traffic participants who will interfere with the lane change on the assumption that the lane change has been executed.

When it is determined that a lane change is possible, the turn signal controller 170 causes the turn signal 42 to operate (step S106). Processing of step S106 may be performed before step S104. The action plan generator 140 determines whether a predetermined time has elapsed from the time when the turn signal 42 is operated and whether a lane change is possible as in step S104 (step S108).

When it is determined that a predetermined time has elapsed from the time when the turn signal 42 is operated and that a lane change is possible as in step S104, the action plan generator 140 causes the vehicle M to start the lane change (step S110). When the determination of step S104 or step S108 has been repeated over a predetermined time and it is not determined that a lane change is possible during this period, processing of changing lanes may be stopped temporarily and the lane change may be attempted after a predetermined time has elapsed. As a result, processing of one routine of this flowchart ends.

As described above, the action plan generator 140 causes the vehicle M to start a lane change after a predetermined time has elapsed from the time when the turn signal 42 is operated when the start condition for the lane change is satisfied. As a result, the vehicle M can sufficiently notify the traffic participants in the vicinity of the future behavior of the vehicle M.

[Flowchart (Second Control)]

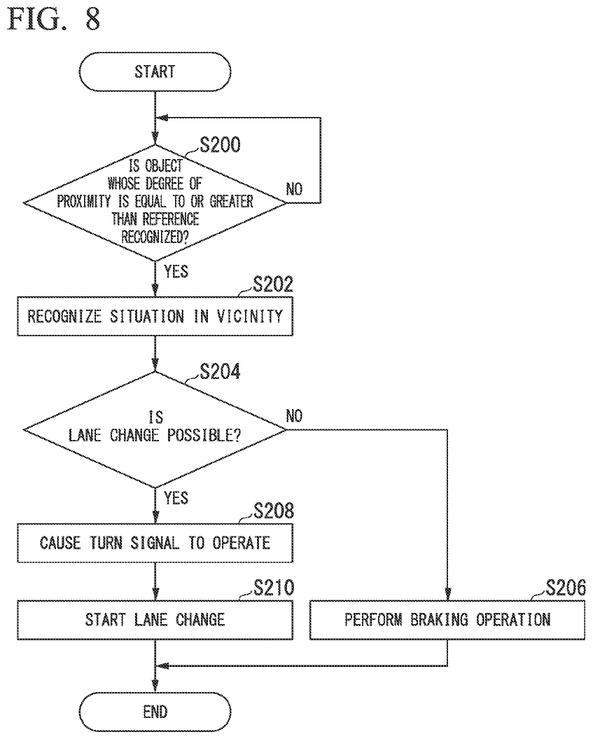

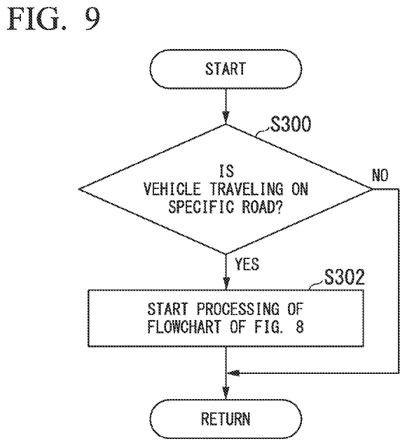

FIG. 8 is a flowchart which shows an example of the flow of the processing executed by the automated driving control device 100. The order of the processing executed in this flowchart may be changed, or a part of the processing may also be omitted. This processing is executed in parallel with the processing in the flowchart of FIG. 7, for example.

First, the action plan generator 140 determines whether an object whose degree of proximity is equal to or greater than the reference is recognized on the basis of a result of recognition by the recognizer 130 (step S200). When the recognizer 130 recognizes an object whose degree of proximity is equal to or greater than the reference, it recognizes the vicinity of the vehicle M again (step S202).

Next, the action plan generator 140 determines whether a lane change is possible on the basis of a result of the recognition in step S202 (step S204). When a lane change is not possible, the action plan generator 140 performs a braking operation (step S206). A fact that the lane change is not possible means that the vehicle M interferes with a following vehicle (or a vehicle present in a lateral direction) if the vehicle M changes lanes. As a result, the vehicle M decelerates and, for example, stops or decelerates in front of the object.

When it is determined that a lane change is possible, the turn signal controller 170 causes the turn signal 42 to operate (step S208). A lane change being possible means that the vehicle M does not interfere with a following vehicle even if the vehicle M changes lanes. The action plan generator 140 causes the vehicle M to start changing lanes regardless of the operation and the operation time of the turn signal 42 (step S210). As a result, processing of one routine of this flow chart ends. When processing in the flowchart of FIG. 7 is being performed and the degree of proximity is determined to be equal to or greater than the reference in the processing of step S202 of FIG. 8, each processing of FIG. 8 is prioritized over the processing in the flowchart of FIG. 7.

As described above, since the action plan generator 140 causes the vehicle M to start changing lanes regardless of the operation state or operating time of the turn signal 42 when the degree of proximity is equal to or greater than the reference, it is possible to avoid an object more reliably while suppressing burdens on the occupant or the traffic participants in the vicinity.

According to the first embodiment described above, the action plan generator 140 can realize more appropriate vehicle control according to a presence of an object by changing a timing at which a mobile object starts to move in a direction intersecting the traveling direction with respect to the operation of the turn signal 42 when the degree of proximity is less than the reference or the degree of proximity is equal to or greater than the reference.

[Modified Example]

In the following description, a modified example of the first embodiment will be described. In the first embodiment, the type of a road on which the second control is performed is not considered. In the modified example of the first embodiment, the second control is executed when the vehicle M is traveling on a specific road. Hereinafter, the modified example of the first embodiment will be described.

FIG. 9 is a flowchart which shows an example of a flow of processing of the modified example of the first embodiment executed by the automated driving control device 100. First, the action plan generator 140 determines whether the vehicle M is traveling on a specific road (described below) (step S300). If the vehicle M is not traveling on a specific road, the second control is not executed. In this case, for example, control different from the second control is executed. The different control is, for example, control in which a braking operation is performed so that the vehicle M does not approach an object in front in priority of the vehicle M moving laterally to avoid the object. When the vehicle M is traveling on a specific road, processing of the flowchart of FIG. 8 is started (step S302). As a result, processing of one routine of this flowchart ends.

The “specific road” is a road in which it is considered preferable that the vehicle M moves laterally to avoid an object, rather than the vehicle M performing a braking operation not to approach the object. The “specific road” is, for example, a road having a speed restriction of a predetermined speed or more, an expressway, a main road, a road having two or more lanes for traveling in the same direction, and the like. Information indicating that a road is such a specific road is associated with the first map information 54 or the second map information 62.

As described above, the action plan generator 140 can realize more appropriate vehicle control according to the presence of an object by starting to cause the vehicle M to move in the direction intersecting the traveling direction before the turn signal 42 is operated or the time when a predetermined time has elapsed from starting of operating the turn signal when the vehicle M is traveling on a specific road and the degree of proximity is equal to or greater than the reference.

### Second Embodiment

In the following description, a second embodiment will be described. In the first embodiment, it is assumed that the automated driving control device 100 controls the vehicle M. In the second embodiment, a driving support device supports driving performed by the occupant of the vehicle M. Hereinafter, differences from the first embodiment will be mainly described.

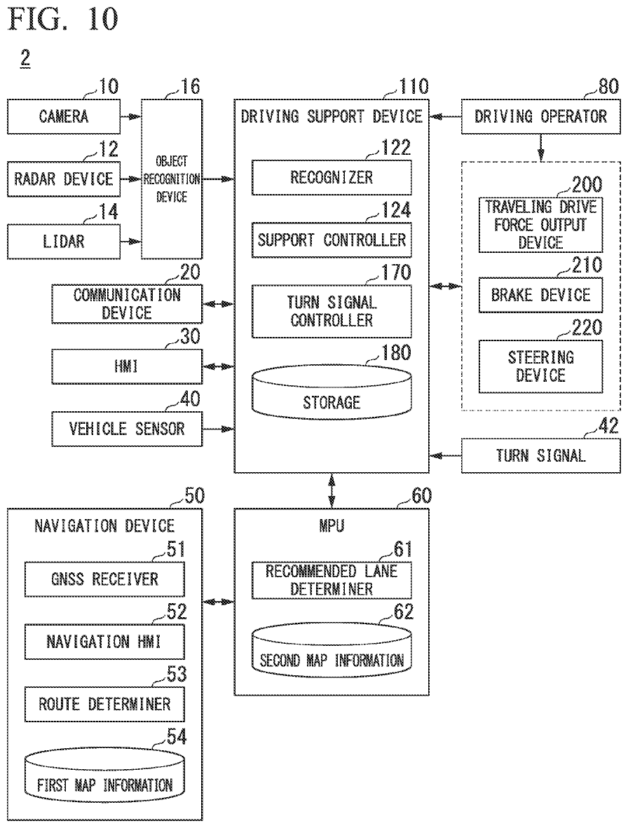

FIG. 10 is a diagram which shows an example of a functional configuration of a control system 2 of the second embodiment. The control system 2 includes a driving support device 110 instead of the automated driving control device 100 of the control system 1. In the control system 1, the MPU 60 may be omitted.

The driving support device 110 includes, for example, a recognizer 122, a support controller 124, a turn signal controller 170, and a storage 180. The recognizer 122, the turn signal controller 170, and the storage 180 have the same functional configurations as the recognizer 130, the turn signal controller 170, and the storage 180 of the first embodiment, respectively.

The support controller 124 supports the driving performed by the occupants of the vehicle M. Supporting is a function in which at least one of the speed or steering of the vehicle M is controlled by a control device of the vehicle M. The support controller 124 executes, for example, adaptive cruise control (ACC) that controls the vehicle M such that it travels while maintaining a constant inter-vehicle distance from a preceding vehicle, or executes a lane keeping assist system (LKAS) that controls the vehicle M such that it travels while maintaining a predetermined distance between the vehicle M and a road lane marking.

When the degree of proximity between the vehicle M and the object is less than the reference, the support controller 124 restricts causing the vehicle M to start a behavior of moving in the direction intersecting the traveling direction in a first degree before a predetermined time elapses from the operation of the turn signal 42. When the degree of proximity described above is equal to or greater than the reference, the support controller 124 relaxes the restriction of the first degree before a predetermined time elapses from the operation of the turn signal 42.

The “restriction” is, for example, a restriction related to steering reaction force, and relaxation of the restriction is relaxation of a magnitude of operation reaction force or relaxation of a time during which operation reaction force is applied. The relaxation of the restriction is to release a function performed by the support controller 124. For example, control relaxation means that the LKAS function may be released and the operation of the occupant is prioritized over control by the support controller 124.

For example, when the LKAS function is applied, the LKAS function is executed until a predetermined time elapses from the operation of the turn signal when the degree of proximity is less than the reference, and the LKAS function is released before a predetermined time elapses from the operation of the turn signal when the degree of proximity is equal to or greater than the reference. Maintaining the LKAS function means that predetermined steering reaction force acts on the steering wheel, and the vehicle M is controlled such that it travels while a predetermined distance is maintained from a road lane marking. Regardless of the turn signal, when the occupant applies predetermined external force or more to the steering wheel, the LKAS function is released. Details of the “restriction” and the “relaxation of the restriction” will be described below.

[Flowchart]

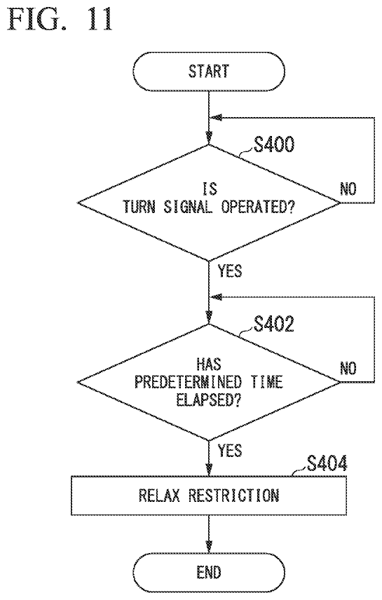

FIG. 11 is a flowchart which shows an example of a flow of processing executed by the support controller 124. This processing is, for example, processing executed when the support controller 124 is executing driving support. First, the support controller 124 determines whether the turn signal 42 has been operated (or whether the occupant has turned on the turn signal 42) (step S400). When the turn signal 42 is operated, the support controller 124 determines whether a predetermined time has elapsed (step S402). When the predetermined time has elapsed, the support controller 124 relaxes the restriction on the steering reaction force (step S404). As a result, processing of one routine of this flowchart ends.

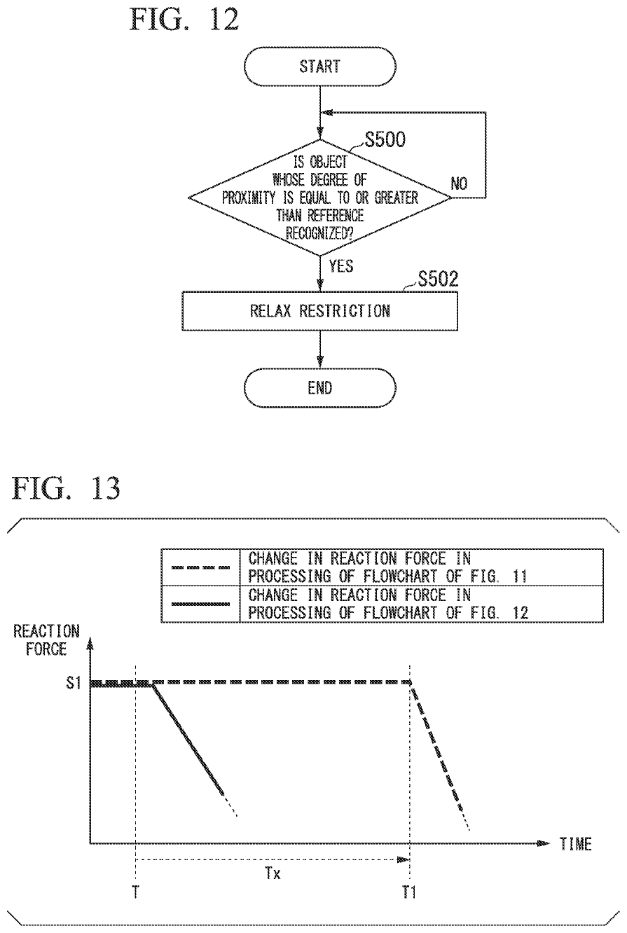

FIG. 12 is a flowchart which shows an example of the flow of the processing executed by the support controller 124. This processing is, for example, processing executed when the support controller 124 is executing driving support, and is processing executed in parallel with FIG. 11 described above.

First, the support controller 124 determines whether an object whose degree of proximity is equal to or greater than the reference is recognized (step S500). When an object whose degree of proximity is equal to or greater than the reference is recognized, the support controller 124 relaxes control of the first degree (step S502). As a result, processing of one routine of this flowchart ends. When the degree of proximity is equal to or greater than the reference and the turn signal 42 is operated, the processing of step S502 of FIG. 12 is prioritized over the processing of step S402 of FIG. 11.

FIG. 13 is a diagram for describing the relaxation of restrictions. A vertical axis of FIG. 13 represents reaction force, and a horizontal axis of FIG. 13 represents a time. At a time T, when the degree of proximity is less than the reference and the turn signal 42 is operated, reaction force of steering is controlled such that it becomes smaller than the first degree S1, decreasing by a first degree or decreasing a degree more than the first degree, after a predetermined time Tx elapses from starting of operating the turn signal (T). A time T1 at which the predetermined time Tx has elapsed is, for example, a timing at which the LKAS function is released.

On the other hand, at the time T, when the degree of proximity is equal to or greater than the reference, the steering reaction force is quickly controlled to be smaller (or to be zero) than the first degree. In this manner, when the support controller 124 executes driving support and the degree of proximity is equal to or greater than the reference, the support controller 124 executes the driving support (for example, LKAS) and relaxes the restriction of the first degree by advancing a timing (a timing at which the driving support is released) at which the steering reaction force is reduced compared with a timing at which the steering reaction force is reduced when the degree of proximity is less than the reference. As a result, the occupant of the vehicle M can change lanes more easily and avoid an object.

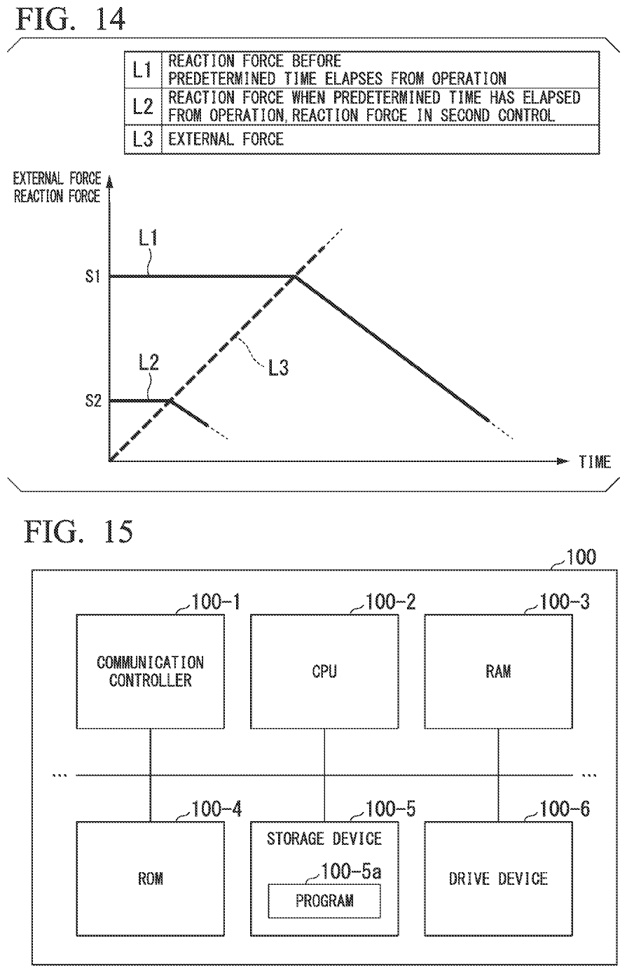

Relaxation may be a manner shown in FIG. 14. FIG. 14 is a diagram which shows an example of a relationship between reaction force and external force before and after the restrictions described above are relaxed. The vertical axis of FIG. 14 indicates the reaction force or the external force, and the horizontal axis of FIG. 14 indicates a time.

For example, in the first control, before a predetermined time elapses from the operation of the turn signal, when an external force exceeding the reaction force S1 is applied to the steering wheel, the reaction force is controlled to decrease, and the reaction force is controlled to decrease when an external force exceeding reaction force S2 (reaction force smaller than the reaction force S1) is applied to the steering wheel after a predetermined time has elapsed from the operation of the turn signal. In the second control, the reaction force is controlled so that the reaction force gradually decreases when the external force S2 is applied to the steering even before a predetermined time has elapsed from the operation of the turn signal. In this aspect, the processing of step S402 (processing for determining whether a predetermined time has elapsed) may be omitted in the flowchart of FIG. 11 described above.

In this manner, the support controller 124 executes driving support, executes the driving support when the degree of proximity is equal to or greater than the reference, and relaxes the restriction of the first degree by decreasing the steering reaction force on the basis of an external force smaller than when the degree of proximity is less than the reference. As a result, the occupant of the vehicle M can change lanes more easily and avoid the object.

According to the second embodiment described above, when the degree of proximity is less than the reference, the action plan generator 140 restricts causing the vehicle M to start a behavior of moving in the direction intersecting the traveling direction before a predetermined time elapses from the operation of the turn signal 42 in a first degree, and relaxes the restriction of the first degree before the predetermined time elapses from the operation of the turn signal 42 when the degree of proximity is equal to or greater than the reference, thereby realizing more appropriate control of the vehicle M according to the presence of an object.

The second embodiment and the modified example of the first embodiment may be executed in combination. For example, control of the second embodiment may be executed when the vehicle M is traveling on a specific road. The process of performing restriction on steering as described above is not limited to driving support, and may be executed even during manual driving. For example, a predetermined degree of steering reaction force is given before a predetermined time elapses in the first control, and steering reaction force smaller than the steering reaction force described above may be given or the steering reaction force may be released even if the predetermined time has not elapsed in the second control.

[Hardware Configuration]

FIG. 15 is a diagram which shows an example of a hardware configuration of the automated driving control device 100 of the embodiment. As shown in FIG. 15, the automated driving control device 100 is configured by connecting a communication controller 100-1, a CPU 100-2, a random access memory (RAM) 100-3 used as a working memory, a read only memory (ROM) 100-4 that stores a booting program, a storage device 100-5 such as a flash memory or a hard disk drive (HDD), a drive device 100-6, and the like to each other by an internal bus or a dedicated communication line. The communication controller 100-1 communicates with a component other than the automated driving control device 100. The storage device 100-5 stores a program 100-5a executed by the CPU 100-2. This program is expanded to the RAM 100-3 by a direct memory access (DMA) controller (not shown) or the like, and is executed by the CPU 100-2. As a result, a part or all of the first controller 120, the second controller 160, and functional units included therein are realized.

The embodiment described above can be expressed as follows.

A control device is configured to include a storage device that has stored a program, and a hardware processor, in which the hardware processor executes a program stored in the storage device, thereby detecting an object that is present in a traveling direction of a road on which a mobile object is traveling, controlling a behavior of the mobile object, acquiring an operation state of a turn signal that notifies traffic participants in the vicinity of the mobile object that the mobile object moves laterally, starting to cause, when a degree of proximity between the mobile object and the detected object is less than a reference, the mobile object to move in a direction intersecting a traveling direction when a predetermined time has elapsed from starting of operating the turn signal obtained from the operation state of the turn signal, and starting to cause, when the degree of proximity is equal to or greater than the reference, the mobile object to move in a direction intersecting a traveling direction before the turn signal is operated or before a predetermined time has elapsed from starting of operating the turn signal.

Although forms for implementing the present invention have been described above using the embodiments, the present invention is not limited to these embodiments, and various modifications and substitutions can be made within a range not departing from the gist of the present invention.

What is claimed is:

1. A control device comprising:
a memory that stores instructions; and
one or more processors that execute the instructions to:
detect an object that is present in a traveling direction of a road on which a mobile object is traveling,
control a behavior of the mobile object,
acquire an operation state of a turn signal that notifies traffic participants in a vicinity of the mobile object that the mobile object moves laterally,
cause, when a degree of proximity between the mobile object and the detected object is less than a reference, the mobile object to move in a direction intersecting the traveling direction when a predetermined time has elapsed from starting of operating the turn signal obtained from the operation state of the turn signal, and
cause, when the degree of proximity is equal to or greater than the reference, the mobile object to move in the direction intersecting the traveling direction before the turn signal is operated or before the predetermined time has elapsed from starting of operating the turn signal.

2. The control device according to claim 1,
the one or more processors that execute the instructions to:
determine that the degree of proximity is equal to or greater than the reference when a first time until the mobile object reaches a reference position of the object is equal to or less than a first threshold value or when a second time until the mobile object passes through a predetermined position after the object passes through the predetermined position is equal to or less than a second threshold value, and cause the mobile object to move in the direction intersecting the traveling direction before the turn signal is operated or before a predetermined time has elapsed from starting of operating the turn signal.

3. The control device according to claim 1,
wherein, when a speed of the object is less than a speed of the mobile object by a predetermined speed or more, the one or more processors execute instructions to: cause the mobile object to move in the direction intersecting the traveling direction before the turn signal is operated or before a predetermined time has elapsed from starting of operating the turn signal.

4. The control device according to claim 3,
wherein the one or more processors execute instructions to: determine that the degree of proximity is equal to or greater than a reference when a distance between the mobile object and the object is less than a reference distance or when an index obtained by dividing the distance by a speed obtained by subtracting the speed of the object from the speed of the mobile object is less than a reference index, and cause the mobile object to move in the direction intersecting the traveling direction before the turn signal is operated or before a predetermined time has elapsed from starting of operating the turn signal.

5. The control device according to claim 4,
wherein the one or more processors execute instructions to: determine that the degree of proximity is less than a reference when a distance between the mobile object and the object exceeds a reference distance or when an index obtained by dividing the distance by a speed obtained by subtracting the speed of the object from the speed of the mobile object exceeds a reference index, and cause the mobile object to move in the direction intersecting the traveling direction when a predetermined time has elapsed from starting of operating the turn signal.

6. The control device according to claim 1,
wherein the one or more processors execute instructions to: causes the mobile object to move in the direction intersecting the traveling direction to change a lane of the mobile object from a lane in which the mobile object is traveling to a lane adjacent to the lane.

7. The control device according to claim 1,
wherein, when the mobile object is traveling on a specific road and the degree of proximity is equal to or greater than a reference, the one or more processors execute instructions to: cause the mobile object to move in the direction intersecting the traveling direction before the turn signal is operated or before a predetermined time has elapsed from starting of operating the turn signal, and
the specific road is a road whose restriction speed is equal to or greater than a predetermined speed.

8. A control device comprising:
a memory that stores instructions; and
the one or more processors that execute the instructions to:
detect an object that is present in a traveling direction of a road on which a mobile object is traveling,
control a behavior of the mobile object,
restrict, when a degree of proximity between the mobile object and the detected object is less than a reference, causing the mobile object to start a behavior of moving in a direction intersecting the traveling direction in a first degree before a predetermined time has elapsed from an operation of a turn signal that notifies traffic participants in the vicinity of the mobile object that the mobile object is moving laterally, and
relax the restriction of the first degree before a predetermined time has elapsed from the operation of the turn signal when the degree of proximity is equal to or greater than the reference.

9. A vehicle control method using a vehicle control device, the vehicle control method comprising:
processing of detecting an object that is present in a traveling direction of a road on which a mobile object is traveling;
processing of controlling a behavior of the mobile object;
processing of acquiring an operation state of a turn signal that notifies traffic participants in a vicinity of the mobile object that the mobile object moves laterally;
processing of starting to cause, when a degree of proximity between the mobile object and the detected object is less than a reference, the mobile object to move in a direction intersecting the traveling direction when a predetermined time has elapsed from starting of operating the turn signal obtained from the operation state of the turn signal; and
processing of starting to cause, when the degree of proximity is equal to or greater than the reference, the mobile object to move in the direction intersecting the traveling direction before the turn signal is operated or before a predetermined time has elapsed from starting of operating the turn signal.
